(19) United States
(12) Patent Application Publication
(10) Pub. No.: US 2002/0068202 A1
(43) Pub. Date: Jun. 6, 2002

(54) Method for cold-starting a fuel cell battery, and fuel cell battery suitable for this method

(76) Inventors: Ulrich Gebhardt, Langensendelbach (DE); Manfred Waidhas, Nurnberg (DE)

Correspondence Address: LERNER AND GREENBERG, P.A., PATENT ATTORNEYS AND ATTORNEYS AT LAW, Post Office Box 2480, Hollywood, FL, 33022-2480, US

(21) Appl. No.: 09/968,305

(22) Filed: Oct. 1, 2001

Related U.S. Application Data
(63) Continuation of application No. PCT/DE00/00674, filed on Mar. 3, 2000.

(30) Foreign Application Priority Data
Mar. 29, 1999 (DE) 199 14 249.1

(51) Int. Cl. H01M 8/04

(52) U.S. Cl. 429/13; 429/26

(57) ABSTRACT

The invention relates to a PEM or PAFC fuel cell battery with heater element and improved cold-starting performance, and to a method for cold-starting such a battery, in which the heater element initially heats up a minimal area of a fuel cell unit, from which autothermal heating-up of the entire battery then becomes possible.

### CROSS-REFERENCE TO RELATED APPLICATION

This application is a continuation of copending International Application No. PCT/DE00/00674, filed Mar. 3, 2000, which designated the United States.

### BACKGROUND OF THE INVENTION

1. Field of the Invention

The invention lies in the field of fuel cells. The invention relates to a method for cold-starting a fuel cell battery, in particular, a fuel cell battery with Polymer Electrolyte Membrane (PEM) fuel cells or Phosphoric Acid Fuel Cell (PAFC) fuel cells. In addition, the invention also relates to the fuel cell battery that is suitable for the method. In such a context, the term PEM fuel cell denotes a fuel cell with an ion-conductive membrane, and the term PAFC denotes a fuel cell that uses phosphoric acid as the electrolyte, and the appropriate starting properties are referred to as the cold-start performance.

A fuel cell battery has an electrolyte for each fuel cell unit, for example, in the case of the PEM fuel cell, an ion exchange membrane that contains a sulfonated chemical compound as its principal constituent. The group of chemical compounds binds water in the membrane to ensure sufficient proton conductivity. At a temperature of below 0° C., the membrane resistance suddenly rises by 2 to 3 powers of ten on account of the stored water freezing. As a result, autothermal heating of a fuel cell unit is not possible without further measures. In other fuel cells, such as for example, the PAFC (phosphoric acid fuel cell), the drastically increased resistance during solidification of the electrolyte makes the cold starting of the fuel cell battery more difficult even at relatively high temperatures.

To solve the problem, at a low ambient temperature, it is either possible for the battery—even when it is not being used—to be operated with a minimal load, so that the temperature does not drop below the freezing point. It is also possible to install a temperature sensor that is used to make the battery respond at a temperature at which the electrolyte resistance threatens to rise suddenly. Through operation, it is possible to keep the fuel cell at a temperature that is above the freezing point of the electrolyte.

Short-circuit operation, in which the battery is constantly short-circuited during the heating-up phase, so that at the start of operation the entire fuel cell power is consumed as short-circuit heat to heat up the electrolyte, is also possible.

However, a drawback specifically of short-circuit operation is that the extremely high resistance of the electrolyte at temperatures below the freezing point has to be overcome until the cell starts to run and, as a result, can heat up.

German Patent DE 197 57 318 C2 discloses a PEM fuel cell that is intended to be heatable by electrical heating accommodated in the interior of the cell. In the configuration, the thermal energy is to be generated directly in the electrode/electrolyte unit, and the energy losses are to be minimized. In particular, an internal barrier layer is used as electrical heating that is heated over the entire area by an energy supply.

Accordingly, only methods for cold-starting a fuel cell battery that have an increased consumption of reaction gas during starting and/or during standby operation or that require a very long starting time are in the prior art.

### SUMMARY OF THE INVENTION

It is accordingly an object of the invention to provide a method for cold-starting a fuel cell battery, and fuel cell battery suitable for the method that overcomes the hereinafore-mentioned disadvantages of the heretofore-known methods and devices of this general type and that allows the fuel cell battery to be cold-started with the minimal possible supply of external energy and that provides suitable fuel cell batteries with improved cold-start performance.

With the foregoing and other objects in view, there is provided, in accordance with the invention, a method for cold-starting a fuel cell battery, including the steps of providing a fuel cell battery including fuel cell units stacked to form a fuel cell stack, each fuel cell unit having an electrolyte with electrodes on both sides as anode and cathode, externally heating the electrolyte in at least one of the fuel cell units with at least one heater element, continuing the external heating only until an electrolyte resistance in a cell surface locally at the heater element is sufficiently low to make possible fuel cell operation in the surface, and autothermally heating up the electrolyte over a remaining surface of the fuel cell unit starting from the heater element and stepwise autothermally heating up other of the fuel cell units of the fuel cell stack.

With the objects of the invention in view, there is also provided a cold-starting fuel cell battery including a fuel cell stack formed from individual fuel cell units each of the fuel cell units having an electrolyte with electrodes on both sides as anode and cathode, the fuel cell units including at least one of a PEM fuel cell unit and PAFC fuel cell unit, and at least one heater element integrated in at least one of the fuel cell units.

In the method according to the invention, to cold-start a fuel cell battery, a heater element in a fuel cell unit is externally heated until the electrolyte resistance has become so low that the further heating-up of the battery can take place autothermally. In the associated fuel cell battery with a fuel cell stack formed from stacked fuel cells, the stack includes at least one PEM and/or PAFC fuel cell unit with at least one integrated heater element.

Advantageously, in the invention, the heater element is as compact, i.e., thin and narrow, as possible, so that it can be integrated, for example, in the electrolyte without increasing the volume of the electrolyte. The heater element is preferably connected to an energy source, from which it is supplied with energy when starting.

The material for the heating element is preferably metal and/or plastic with thermal and/or electron conductivity, carbon paper, woven fabric, or the like. A wire sheathed with plastic is a possible configuration. It is also possible for the gas diffusion layer that is present in fuel cells, for example, the carbon paper, or a narrow strip, which is preferably electrically insulated from the remaining diffusion layer, to be used as the heater element.

The heater element is preferably a wire or a narrow strip that may be made of various materials with thermal and/or electron conductivity. The heater element preferably directly heats only a narrow region of the electrolyte, from which, using what is referred to as the domino effect, the entire electrolyte and/or the entire membrane is then heated. The wire may be integrated, for example, in the membrane by lamination. A further advantage of such a configuration is that the heater element additionally imparts mechanical strength to the membrane.

In the invention, a heater element is present at least in one fuel cell unit of the fuel cell stack. Depending on the size of the individual heater element, it may also be advantageous for a plurality of heater elements to be accommodated in a fuel cell unit. The number, size, material, and form of the heater elements are dependent on the configuration of the particular fuel cell battery and are not in any way intended to restrict the scope of the invention.

In accordance with another feature of the invention, the heater element is disposed on at least one of the anode and the cathode.

In accordance with a further feature of the invention, the heater element is a wire.

In accordance with an added feature of the invention, the heater element is integrated in the electrolyte.

In accordance with an additional feature of the invention, the heater element is to be connected to an energy source, preferably, an external energy source.

With the objects of the invention in view, there is also provided a cold-starting fuel cell battery, including a fuel cell stack formed from individual fuel cell units, each of the fuel cell units having an electrolyte with electrodes on both sides as anode and cathode, and at least one heater element for externally heating the electrolyte only until an electrolyte resistance in a cell surface of at least one of the fuel cell units locally at the heater element is sufficiently low to make possible fuel cell operation in the cell surface and for autothermally heating up the electrolyte over a remaining surface of the at least one of the fuel cell units starting from the at least one heater element and stepwise autothermally heating up other of the fuel cell units of the fuel cell stack, the at least one heater element connected to the electrolyte at the cell surface.

Other features that are considered as characteristic for the invention are set forth in the appended claims.

Although the invention is illustrated and described herein as embodied in a method for cold-starting a fuel cell battery, and fuel cell battery suitable for the method, it is, nevertheless, not intended to be limited to the details shown because various modifications and structural changes may be made therein without departing from the spirit of the invention and within the scope and range of equivalents of the claims.

The construction and method of operation of the invention, however, together with additional objects and advantages thereof, will be best understood from the following description of specific embodiments when read in connection with the accompanying drawings.

### BRIEF DESCRIPTION OF THE DRAWINGS

FIG. 1 is a plan view of a diagrammatic illustration of an element in a fuel cell unit with integrated heater element according to the invention;

FIGS. 2A to 2C are three graphs illustrating a change in the resistance over the surface of the fuel cell over the course of time according to the invention; and

FIGS. 3A to 3C are three graphs illustrating a respective heating power consumed according to the invention over three time periods.

### DESCRIPTION OF THE PREFERRED EMBODIMENTS

A fuel cell battery includes at least one stack having at least one fuel cell unit, the corresponding process-gas supply and discharge passages (process-gas passage), a cooling system, and associated end plates.

A fuel cell unit includes at least one electrolyte that is adjoined on both sides by electrodes that, in turn, are adjoined by a gas diffusion layer, through which the reaction gas in the reaction chamber diffuses to the electrode in order to react. The electrodes include, for example, an electrocatalyst layer, and the gas diffusion layer is formed, for example, by a carbon paper.

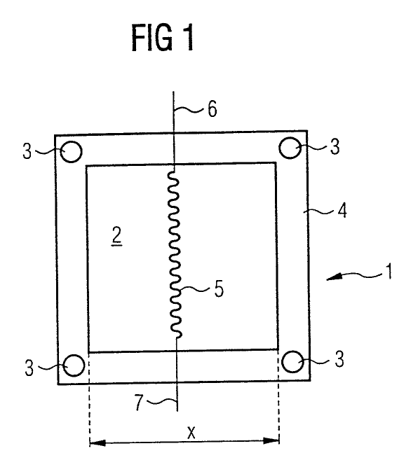

Referring now to the figures of the drawings in detail and first, particularly to FIG. 1 thereof, there is shown a plan view of a fuel cell unit 1. The fuel cell units are preferably polymer electrolyte membrane cells that are also used, for example, in mobile applications. PAFC fuel cell units are also possible.

FIG. 1 illustrates the active cell surface 2, the extent of which corresponds to the length of section x, and the four axial process-gas passages 3 and the edge region 4 of the fuel cell can be seen. A heater element 5 is centrally disposed in the active cell surface.

In FIG. 1, the heater element 5 is configured as a coiled wire that is either laminated directly into the membrane or rests thereon. The wire 5 may equally well be disposed in and/or behind the membrane, an electrode, a gas diffusion layer, i:5 and/or a cell plate. A line 6 leads to the wire 5 that connects the heater element to an external energy source. The line 6 may run directly to the energy source or may run through other heater elements, for example, connected in series. In FIG. 1, a second line 7, which either leads back to the energy source or leads to other, for example ,series-connected heater elements, leads away from the heater element 5.

The preferred form of the heater element 5 is naturally such that it causes the minimum possible disruption in the component of the fuel cell unit in which it is integrated and suffers the minimum possible damage during normal operation. For example, the heater element as a bare metal wire can be successfully integrated both in the gas diffusion layer and in the pole plate. The wire that is covered, for example, with a thermally conductive plastic can also expediently be accommodated or laminated in the electrolyte, such as, for example, in the polymer membrane. According to one specific embodiment, the heater element 5 is integrated in one or both gas diffusion layers of a fuel cell unit.

The heater element 5 illustrated in FIG. 1 can be started independently of operation of the fuel cell battery, for which purpose an external energy source is required. The external energy source is a storage battery and/or a battery that, for example, can be recharged during operation by the fuel cell installation. However, the external energy source may equally be an electrical connection to a network, for example to the mains.

In the method carried out using a configuration as illustrated in FIG. 1, first of all the heater element 5 is started. The heater element 5, as it is heating up, also heats the immediate surroundings, so that, as shown in FIG. 1 where the heater element is integrated as a wire in the center of the electrolyte, in the region the electrolyte rapidly reaches temperatures that are higher than its freezing point.

The advantage of the locally very tightly restricted heating is that substantially less energy is required to heat the membrane adjacent to the heater element. The energy consumption is lowest if the heater element(s) is (are) directly integrated or laminated into the membrane. The heater element is switched off at the earliest when the electrolyte has reached a temperature above its freezing point at least at one location. From then on, conventional autothermal heating is possible.

The term autothermal heating refers to the effect according to which, triggered by a location in the electrolyte that may be as narrow as desired, the following domino effect occurs: the resistance in the electrolyte falls at the heater element, so that reaction and current generation can take place. The waste heat from such a reaction, which takes place along the narrow heated region, heats the adjoining region, in which the electrolyte resistance then likewise falls. As a result, a further reaction area is “opened up”, i.e., becomes accessible, and the further reaction area, in turn, heats the adjoining area, until the entire surface is covered.

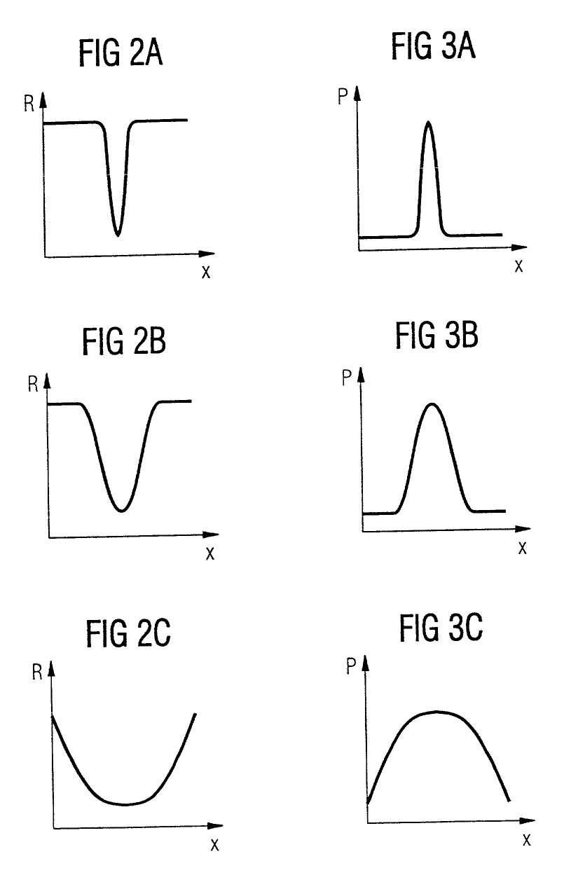

FIGS. 2 and 3 illustrate resistance profiles 2A to 2C and associated power profiles 3A to 3C of the fuel cell battery. The abscissa indicates the section x that describes the extent of the active cell surface 2 (shown in FIG. 1). In diagrams 2A to 2C, the ordinate indicates the resistance R. In diagrams 3A to 3C, the ordinate indicates the power density P.

At time t1, in accordance with FIGS. 2A and 3A, it is possible to recognize a very narrow area along the section x, i.e., along an edge of the active cell surface, in which the resistance R is low. At time t2, in accordance with FIGS. 2B and 3B, the area is already wider. At time t3, although the curve still has areas in which the power P is low and the resistance R is high, most of the active cell surface 2 has been heated up and supplies current.

With the method that has been described with reference to the figures, it is possible to start a fuel cell battery, in particular, for mobile applications, quickly and inexpensively. The additional configuration outlay is low because parts of the cell itself, such as ,for example, the gas diffusion layer, can be used as the heater element. For mobile applications, for example, the 12 V automobile battery is quite sufficient as an external energy source.

In detail, the heater element, for example, the heater wire, may be disposed at one or different locations in the fuel cell. It is possible for it to be disposed between the membrane and electrode, between the electrode and gas diffusion layer, and between the gas diffusion layer and pole plate. It is also possible for the heater element to be fitted in the gas diffusion layer or in a part of the gas diffusion layer and for the heater element to be positioned behind the pole plate. The specific configuration depends on the particular situation, as a function of practical considerations and the economics of the cell structure. The closer the heater element is to the electrolyte, the more effectively it can operate.

In the described method, the heater element is connected to an energy source. Advantageously, it is connected to an external energy source through an electrical line. The term external energy source denotes any energy source outside the fuel cell battery itself that is to be heated up.

We claim:

1. A method for cold-starting a fuel cell battery, which comprises:
providing a fuel cell battery including fuel cell units stacked to form a fuel cell stack, each fuel cell unit having an electrolyte with electrodes on both sides as anode and cathode;
externally heating the electrolyte in at least one of the fuel cell units with at least one heater element;
continuing the external heating only until an electrolyte resistance in a cell surface locally at the heater element is sufficiently low to make possible fuel cell operation in the surface; and
autothermally heating up the electrolyte over a remaining surface of the fuel cell unit starting from the heater element and stepwise autothermally heating up other of the fuel cell units of the fuel cell stack.

2. A cold-starting fuel cell battery, comprising:
a fuel cell stack formed from individual fuel cell units each of said fuel cell units having an electrolyte with electrodes on both sides as anode and cathode;
said fuel cell units including at least one of a PEM fuel cell unit and PAFC fuel cell unit; and
at least one heater element integrated in at least one of said fuel cell units.

3. The fuel cell battery according to claim 2, wherein said heater element is disposed on at least one of said anode and said cathode.

4. The fuel cell battery according to claim 2, wherein said heater element is a wire.

5. The fuel cell battery according to claim 2, wherein said heater element is integrated in said electrolyte.

6. The fuel cell battery according to claim 2, wherein said heater element is to be connected to an energy source.

7. The fuel cell battery according to claim 6, wherein said energy source is an external energy source.

8. A cold-starting fuel cell battery, comprising:
a fuel cell stack formed from individual fuel cell units, each of said fuel cell units having an electrolyte with electrodes on both sides as anode and cathode; and
at least one heater element for externally heating said electrolyte only until an electrolyte resistance in a cell surface of at least one of said fuel cell units locally at said heater element is sufficiently low to make possible fuel cell operation in said cell surface and for autothermally heating up said electrolyte over a remaining surface of said at least one of said fuel cell units starting from said at least one heater element and stepwise autothermally heating up other of said fuel cell units of said fuel cell stack, said at least one heater element connected to said electrolyte at said cell surface.
